(19) United States
(12) Patent Application Publication
(10) Pub. No.: US 2025/0355710 A1
(43) Pub. Date: Nov. 20, 2025

(54) Near Real-Time Benchmark Data Generation and Display for Dynamic Peer Groups

(71) Applicant: Google LLC, Mountain View, CA (US)

(72) Inventors: Matthew Thompson Walter, Ladera Ranch, CA (US); Jeffrey Allen Bergman, Irvine, CA (US); Kevin Robert Rothi, Huntington Beach, CA (US); Jess Vincent Renteria, Rancho Cucamonga, CA (US); Daniel Gregory Yule, Menlo Park, CA (US); Omer Shakil, Sunnyvale, CA (US); Chunying Li, Santa Clara, CA (US); Matthew James Price, Mercer Island, WA (US)

(21) Appl. No.: 19/203,379

(22) Filed: May 9, 2025

Related U.S. Application Data
(60) Provisional application No. 63/649,536, filed on May 20, 2024.

(51) Int. Cl. G06F 9/50

(52) U.S. Cl. CPC G06F 9/5027

(57) ABSTRACT

Systems and methods include receiving a request for presentation of a benchmark line chart diagram associated with a device identifier. The system can access device identifier data including category data, application data, or traffic volume data. The system can determine a branch of related hierarchical groups for the device identifier based on the device identifier data. The system can access data including cohort groups including a minimum number of device identifiers such that aggregate metric data associated with the cohort does not reveal any information about any single device identifier. The system can select a benchmark group for the device identifier. The system can access data including aggregate metrics associated with the selected benchmark group. The system can transmit data including instructions cause one or more processors to provide for display a benchmark line chart diagram and benchmark metric data indicative of aggregate metrics associated with the benchmark group.

### PRIORITY

The present application claims the benefit of priority of U.S. Provisional Patent Application No. 63/649,536, filed on May 20, 2024, which is incorporated by reference herein.

### FIELD

The present disclosure relates generally to machine learning. More particularly, the present disclosure relates to systems and methods for using machine learning to determine peer groups of content providers and utilize the peer groups to determine and display benchmark metric data in near-real time.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

One example aspect of the present disclosure is directed to an example method. The example method can include obtaining, by a computing system comprising one or more computing devices, time series data comprising a plurality of data items associated with a plurality of times. The example method can include receiving, by a computing device, a request for presentation of a benchmark line chart diagram associated with a device identifier. The example method can include accessing, by the computing device, responsive to receiving the request, device identifier data comprising at least one of (i) category data, (ii) application data, or (iii) traffic volume data. The example method can include determining, by the computing device, a branch of related hierarchical groups for the device identifier based on the device identifier data. The example method can include accessing, by the computing device, data comprising a plurality of cohort groups, wherein the cohort groups comprising a minimum number of device identifiers such that aggregate metric data associated with the cohort does not reveal any information about any single device identifier of the cohort group. The example method can include selecting, based on the cohort groups and the device identifier data, a benchmark group for the device identifier. The example method can include accessing, by the computing device, data comprising aggregate metrics associated with the selected benchmark group. The example method can include transmitting, by the computing device, data comprising instructions that when executed by one or more processors, cause the one or more processors to provide for display a benchmark line chart diagram comprising a trendline of metric data associated with the device identifier, and benchmark metric data indicative of aggregate metrics associated with the benchmark group.

Another example aspect of the present disclosure is directed to an example computing system. The example computing system can include one or more processors. The example computing system can include one or more non-transitory computer-readable media storing instructions that are executable by the one or more processors to cause the computing system to perform example operations. The example operations can include receiving, by a computing device, a request for presentation of a benchmark line chart diagram associated with a device identifier. The example operations can include accessing, by the computing device, responsive to receiving the request, device identifier data comprising at least one of (i) category data, (ii) application data, or (iii) traffic volume data. The example operations can include determining, by the computing device, a branch of related hierarchical groups for the device identifier based on the device identifier data. The example operations can include accessing, by the computing device, data comprising a plurality of cohort groups, wherein the cohort groups comprising a minimum number of device identifiers such that aggregate metric data associated with the cohort does not reveal any information about any single device identifier of the cohort group. The example operations can include selecting, based on the cohort groups and the device identifier data, a benchmark group for the device identifier. The example operations can include accessing, by the computing device, data comprising aggregate metrics associated with the selected benchmark group. The example operations can include transmitting, by the computing device, data comprising instructions that when executed by one or more processors, cause the one or more processors to provide for display a benchmark line chart diagram comprising a trendline of metric data associated with the device identifier, and benchmark metric data indicative of aggregate metrics associated with the benchmark group.

Another example aspect of the present disclosure is directed to one or more non-transitory computer-readable media. The one or more non-transitory computer-readable media can store instructions that are executable by a computing system to perform example operations. The example operations can include receiving, by a computing device, a request for presentation of a benchmark line chart diagram associated with a device identifier. The example operations can include accessing, by the computing device, responsive to receiving the request, device identifier data comprising at least one of (i) category data, (ii) application data, or (iii) traffic volume data. The example operations can include determining, by the computing device, a branch of related hierarchical groups for the device identifier based on the device identifier data. The example operations can include accessing, by the computing device, data comprising a plurality of cohort groups, wherein the cohort groups comprising a minimum number of device identifiers such that aggregate metric data associated with the cohort does not reveal any information about any single device identifier of the cohort group. The example operations can include selecting, based on the cohort groups and the device identifier data, a benchmark group for the device identifier. The example operations can include accessing, by the computing device, data comprising aggregate metrics associated with the selected benchmark group. The example operations can include transmitting, by the computing device, data comprising instructions that when executed by one or more processors, cause the one or more processors to provide for display a benchmark line chart diagram comprising a trendline of metric data associated with the device identifier, and benchmark metric data indicative of aggregate metrics associated with the benchmark group.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example system for determining a benchmark group and generate benchmark graphs according to example embodiments of the present disclosure;

FIG. 2 depicts an example graphical user interface of a hierarchical benchmark group schema according to example embodiments of the present disclosure;

FIG. 3 depicts an example graphical user interface of a benchmark line graph according to example embodiments of the present disclosure;

FIG. 4 depicts an example graphical user interface of a benchmark line graph according to example embodiments of the present disclosure;

FIG. 5 depicts an example graphical user interface of a benchmark line graph according to example embodiments of the present disclosure;

FIG. 6 depicts a flow chart diagram of an example method to determine a benchmark group and generate benchmark graphs according to example embodiments of the present disclosure;

FIG. 7A depicts a block diagram of an example computing system that performs insight summary generation according to example embodiments of the present disclosure;

FIG. 7B depicts a block diagram of an example computing device that performs insight summary generation according to example embodiments of the present disclosure;

FIG. 7C depicts a block diagram of an example computing device that performs insight summary generation according to example embodiments of the present disclosure;

FIG. 8 is a flow chart diagram illustrating an example method of generating adjusted caption data based on emotion tag data of input audio signals according to example implementations of aspects of the present disclosure;

FIG. 9 is a block diagram of an example processing flow for using machine-learned model(s) to process input(s) to generate output(s) according to example implementations of aspects of the present disclosure;

FIG. 10 is a block diagram of an example sequence processing model according to example implementations of aspects of the present disclosure;

FIG. 11 is a block diagram of an example technique for populating an example input sequence for processing by a sequence processing model according to example implementations of aspects of the present disclosure;

FIG. 12 is a block diagram of an example model development platform according to example implementations of aspects of the present disclosure;

FIG. 13 is a block diagram of an example training workflow for training a machine-learned model according to example implementations of aspects of the present disclosure; and

FIG. 14 is a block diagram of an inference system for operating one or more machine-learned model(s) to perform inference according to example implementations of aspects of the present disclosure.

Reference numerals that are repeated across plural figures are intended to identify the same features in various implementations.

### DETAILED DESCRIPTION

Generally, the present disclosure is directed to machine-learned generation of benchmarking data summaries for dynamic peer groups based on time series data (e.g., advertising analytics time series data, etc.). A computing system can perform a structured analysis (e.g., mathematical or algorithmic analysis, etc.) on the time series data to generate benchmark metrics in comparison to individual metrics associated with the time series data. For example, the structured analysis can identify particular trends in the data over time, such as a recent increase or decrease in a numerical value (e.g., impressions, click-through rate, conversion rate, return on ad spend, engagement rate, etc.) associated with the time series data. The structured analysis system can provide insight data in a structured format to a model which can generate a visualization of the summarized data. For instance, the visualization can include a stylized line graph including the performance associated with the individual account as it compares to various percentiles, medians, etc. of peer groups. The peer groups can be automatically determined or adjusted based on characteristics associated with the account and associated categorizations. The numerical values and data that are shown can include normalized and unnormalized data.

In some instances, the peer groups can be generated in a hierarchical structure based on categories and subcategories. For instance, a category could include automobiles, a subcategory could include sport utility vehicles (SUV), and a further subcategory can include a particular brand of SUV. The peer groups can be automatically generated based on a number of other accounts associated with the respective category. For instance, if a metric requires a minimum number of one hundred (100) accounts within a category to form the peer group, the system may select the peer group at various levels of granularity for different categories.

The present disclosure provides for many technical effects and benefits. In particular, some systems can have access to large quantities of data for determining performance of content items or other measurable quantities indicative of performance.

As another example, the peer group generation and benchmark metric evaluation processes can be iteratively improved based on feedback from users. For example, a system can provide a generated benchmark visualization to a user, along with an input component (e.g., thumbs up/down button, etc.) for the user to provide feedback about the quality (e.g., accuracy, relevance, interestingness, usefulness, actionability, etc.) of the generated benchmark visualization. Based on feedback received via the input component, a computing system can further train the peer group generation model and benchmark generation model, or both to further improve the quality of generated outputs.

In some instances, an example generated output can include a title; a line graph providing a trend line of performance associated with an account of a set duration of time; a line graph providing a trend line of performance associated with an aggregated peer group; and shaded regions associated with bands of percentage of performance. As such, the benchmark graph can provide a visualization of performance of an account and associated content items compared to other accounts associated with the same peer group.

In some implementations, the difference between the account performance and the various benchmark values can be utilized to adjust the allocation of resources. For instance, if a certain metric is under performing and an another is over performing, resources can be moved from one designation to another to provide for optimizations of computing resource utilization.

To generate the chart, a computing system can use standard mathematical tools to generate charts directly from time series data, structured insight data, or other data (e.g., without the use of a machine-learned model).

In some instances, an insight can include or be based on a comparison between user-specific data (e.g., data associated with a particular account on an advertising analytics platform, etc.) and general data associated with multiple users (e.g., all users; businesses in a particular industry or market segment; advertisers of a similar size compared to a user of interest; etc.). As an illustrative example, if all clothing websites see an increase in traffic each weekend, then a structured analysis system may determine that a weekend-based increase in traffic is not a very interesting insight to a clothing advertiser. However, if the clothing advertiser saw a much larger or smaller spike in traffic compared to similar advertisers or compared to other weekends, that comparative insight may be more interesting to some users (e.g., as measured by user feedback, etc.).

In some instances, the time series data analyzed, along with the insights generated from the time series data, can include advertising analytics data and advertising analytics insights. Advertising analytics data can include, for example, any data indicative of one or more interactions associated with an advertisement (e.g., impressions, clicks, purchases, interactions with non-advertising content connected to an advertisement, etc.). For example, interaction data can include data associated with an advertisement, viewer, product being advertised or purchased, advertising interaction, non-advertising content, website, or other interaction data. In some instances, advertising analytics data can include segment data (e.g., product segments, viewership segments, advertising campaign segments, non-advertising content segments, website segments, etc.), which can include segment data based on default segmentations and segment data based on user-defined custom segments. As a non-limiting illustrative example, an advertising analytics insight could include, for example, trend data indicating that clickthrough rates have increased in the past week, and a comparison of the trend data of clickthrough for the individual user account as compared to aggregate clickthrough trend data of the peer group of the individual user account.

Systems and methods of the present disclosure can provide a variety of technical effects and benefits, such as improved accuracy of machine-learned outputs; reduced computational cost (e.g., electricity cost, processor usage, etc.) of machine-learned language generation; and reduced cost (e.g., computational cost, labor cost, etc.) of insight extraction.

As another example, systems and methods according to example aspects of the present disclosure may in some instances reduce a computational cost of generating machine-learned insight summarization outputs compared to some alternative methods with a similar accuracy. For example, in some instances, a mathematical and factual accuracy of a machine-learned language output can be increased by increasing a complexity or size (e.g., number of parameters, etc.) of the machine-learned model generating the output. However, increasing a complexity of a machine-learned model can also increase a computational cost (e.g., electricity cost, processor usage, memory usage, hardware cost, etc.) of training the machine-learned model and a computational cost of generating outputs with the machine-learned model after training. In some instances, the increased cost can be very large compared to the improvement in accuracy. For example, a large increase in model complexity (e.g., doubling of parameter count, ten-fold increase in parameter count, etc.) may only lead to a small marginal increase in accuracy (e.g., five percent increase, 25 percent increase, etc.) in a simple (e.g., elementary-school-level) mathematical reasoning task, which may be much simpler mathematically than structured data analysis performed according to some aspects of the present disclosure. Additionally, the increase in accuracy may in some instances have a log-linear relationship with model complexity, meaning that increased complexity will lead to diminishing returns in accuracy as model complexity increases. Advantageously, systems and methods according to some aspects of the present disclosure can provide substantially improved mathematical accuracy (e.g., at or near 100 percent, etc.) compared to alternative methods, without increasing a complexity of the machine-learned language model. In this manner, for instance, systems and methods according to some aspects of the present disclosure can provide machine-learned dynamic benchmark group insight generation at reduced computational cost (e.g., model training costs, inference costs, etc.) compared to alternative methods having a similar mathematical accuracy.

A technical effect of example implementations of the present disclosure is increased energy efficiency in performing operations using machine-learned models, thereby improving the functioning of computers implementing such models. For instance, example implementations can provide for more energy-efficient training operations or model updates by providing error correction using lightweight (e.g., having a lower computational cost or model complexity compared to a machine-learned generative language model) evaluation models or structured data analysis techniques. In some scenarios, increased energy efficiency can provide for less energy to be used to perform a given number of inference or training tasks (e.g., less energy expended to maintain the model in memory, less energy expended to perform calculations within the model, such as computing gradients, backpropagating a loss, etc.). In some scenarios, increased energy efficiency can provide for more inference or training tasks to be completed for a given energy budget (e.g., a larger quantity of training iterations, etc.). In some scenarios, greater expressivity afforded by systems and methods of the present disclosure can provide for a given level of functionality to be obtained in fewer training iterations, thereby expending a smaller energy budget. In some scenarios, greater expressivity afforded by systems and methods of the present disclosure can provide for an extended level of functionality to be obtained in a given number of training iterations, thereby more efficiently using a given energy budget.

In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in toto (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

With reference now to the Figures, example embodiments of the present disclosure will be discussed in further detail.

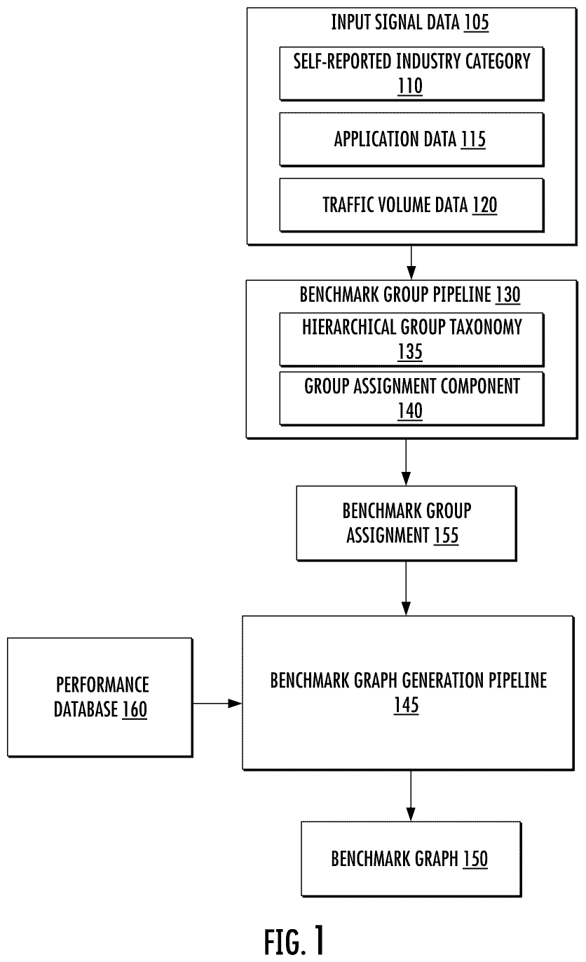

FIG. 1 depicts a block diagram of an example system for assigning benchmark groups and determining benchmark metric data to provide for display via a graphical user interface. For instance, input signal data 105 can be obtained by benchmark group pipeline 130. Input signal data 105 can include self-reported industry category 110, application data 115, traffic volume data 120, or other relevant data. Self-reported industry category 110 can include a category associated with a good or service associated with the device identifier. Application data 115 can include data associated with the utilization of an application associated with the device identifier. Traffic volume data 120 can include an amount of traffic that a website, application, or other surface associated with the device identifier can be utilized.

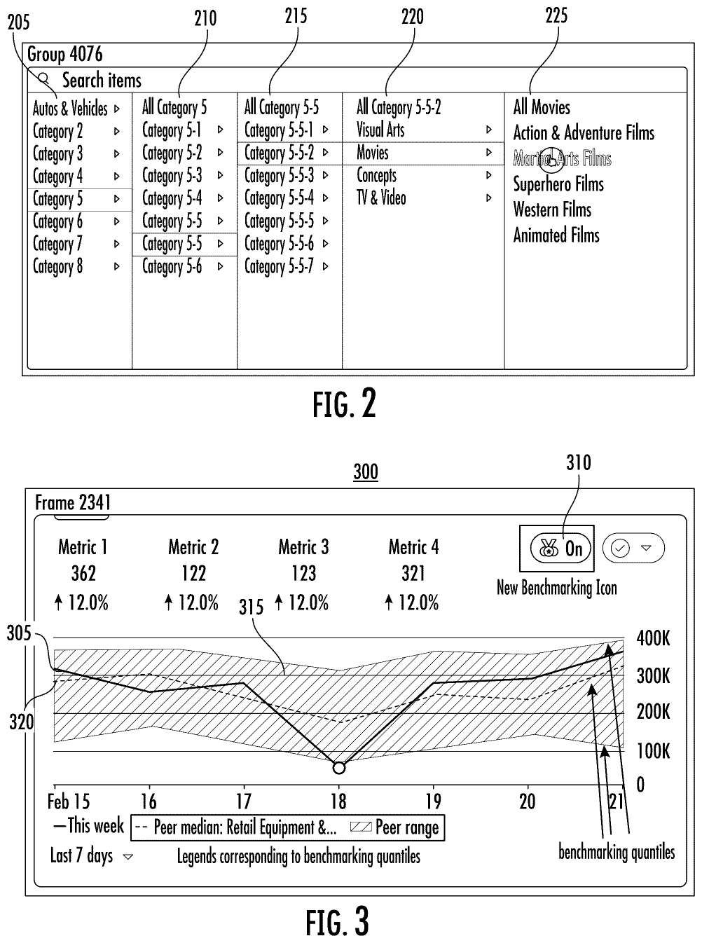

Benchmark group pipeline 130 can receive input signal data 105 and generate benchmark group assignment 155 as output. Benchmark group pipeline 130 can include hierarchical group taxonomy 135 and group assignment component 140. Hierarchical group taxonomy 135 can include a list of hierarchical groups which can be organized in tree fashion. An example hierarchical group tree is depicted in FIG. 2. Group assignment component 140 can select a hierarchical group for the device identifier based on input signal data 105. In some instances, group assignment component 140 selects a node of a hierarchical group branch to select for generating the benchmark grouping for a device identifier. For instance, the system can determine the most granular or specific group that still satisfies one or more requirements for privacy or other utility purposes.

The benchmark group assignment 135 can include an indication of the device identifier and aggregated data associated with all members of the benchmark group. By way of example, device identifier can be a used car sales website. The hierarchical categories associated with the benchmark group can include auto>cars>used>make>model>year. The number of other device identifiers associated with different subgroups may not meet requirements to maintain privacy associated with any individual set of data. For instance, the node of year, model, or make may contain too few a number of device identifiers to use for gleaning meaningful insights. Whereas used, cars, or auto may include enough device identifiers and associated metric data. The group assignment component 140 can determine the most granular or specific benchmark group that can be achieved. Additionally, or alternatively, the group assignment component 140 can assign a device identifier to all relevant categories.

Benchmark graph generation pipeline 145 can obtain benchmark group assignment 155. Benchmark graph generation pipeline 145 can query performance database 160 to obtain data associated with the benchmark group associated with benchmark group assignment 155. Benchmark graph generation pipeline 145 can include determining a trend line for the device identifier that has requested a visual depiction of the performance compared to benchmarked performance of a related benchmark group. In some instances, the relevant data can include determination or extraction of existing or cached calculations for a lower 25 percentile, a median or average percentile, and an up 75^{th} percentile. The benchmark graph generation pipeline 145 can generate benchmark graph 150 as output.

In some instances, benchmark graph generation pipeline can access time series data in a performance database (such as performance database 160). Time series data can include, for example, data comprising a plurality of data items associated with a plurality of times. Each data item of the time series data can include one type or many types of data, and each data item may have a data type that is the same as or different from a data type of another data item of the time series data. Example data types for the time series data can include any type of computer-readable data, such as numerical data, binary data, text data, structured data (e.g., XML, JSON, HTML, object, struct, etc.), or other computer-readable data type.

In some instances, time series data can include advertising analytics data. Advertising analytics data can include, for example, any data indicative of one or more interactions associated with an advertisement (e.g., impressions, clicks, purchases, interactions with non-advertising content connected to an advertisement, etc.). For example, interaction data can include data associated with an advertisement (e.g., format data, content data, identification number, filename, host server, etc.), viewer (e.g., location; demographic information; viewer interests such as purchase interests, hobbies, etc.; device data such as browser(s), application(s), operating system, device name such as Pixel 8 Pro, etc.; associated keywords such as search keywords entered; new or returning viewer status; etc.), product being advertised or purchased (e.g., category, name, identification number, version such as size or color, etc.), advertising interaction (e.g., date of a view, click, visit, purchase, etc.; source of interaction such as search, email, social media, affiliate or referral links, etc.; keyword associated with interaction; purchase data such as coupon data, etc.; funnel data describing series of interactions such as first view→first visit→first purchase, etc.; interaction completion or abandonment data; etc.), non-advertising content (e.g., publication data such as date, title, etc.; game data such as character data, in-game achievement data, etc.), website or other technical component (e.g., filename data, uniform resource locator (URL) data, hypertext markup language (HTML) data such as class name of an HTML element associated with an interaction, etc.). In some instances, advertising analytics data can include segment data (e.g., product segments, viewership segments, advertising campaign segments, non-advertising content segments, website segments, etc.), which can include segment data based on default segmentations and segment data based on user-defined custom segments. In some instances, advertising analytics data can include quantitative data based on or otherwise associated with one or more (e.g., a plurality of) advertising interactions. For example, in some instances, advertising analytics data can include metrics associated with a plurality of interactions, such as count data (e.g., number of impressions in a time period, number of users, number of sessions, etc.), rate or percentage data (e.g., bounce rate, clickthrough rate, average session duration, average pages per session, ratio of new to returning visitors, average time on page, conversion rates, etc.), cost data (e.g., cost per click, cost per conversion, etc.), revenue data (e.g., return on advertising spend, etc.) or other aggregate data associated with a plurality of advertising interactions. In some instances, an advertising interaction can include an internet-based advertising interaction, and data associated with the internet-based advertising interaction can include internet traffic data associated with one or more internet interactions.

Structured data can include, for example, one or more data items in a structured format. In some instances, structured data can include data items correlating numerical data derived from the time series data (e.g., trends, percentages, counts, rates, aggregate statistical data associated with a plurality of advertising interactions, etc.) with one or more other data values, such as advertising analytics data values associated with the times series data from which the numerical data was derived. The one or more other data values can include, for example, metadata such as numerical, binary, or text data indicative of a data category associated with the numerical data (e.g., category name such as clickthrough rate, number of impressions, etc.; category identification number; etc.); a data segment (e.g., subset of the time series data such as demographic segment, product segment, etc.) associated with the numerical data; or other data associated with the numerical data (e.g., website URL, product name or description, other advertising analytics data, etc.). As an illustrative example, structured insight data identifying a recent change in clickthrough rate can include mathematical data describing the change (e.g., magnitude of the change, etc.); time data indicating one or more time periods associated with the change; and data identifying clickthrough rate as the advertising analytics variable that has changed.

Data items in a structured format can include, for example, data objects (e.g., associated with an object-oriented programming language, etc.) or data structures (e.g., structs in a C programming language and the like); database rows or spreadsheet rows; data in a structured text format, such as a data object notation format (e.g., Javascript Object Notation (JSON) format), markup language format (e.g., extensible markup language (XML) format, hypertext markup language (HTML) format, etc.), or other structured format (e.g., comma-separated value (CSV) format, etc.); ordered tuplets or other data formatted according to a predefined order or arrangement; structured format associated with a communication protocol or data storage protocol; files comprising data in a structured format; or other structured data.

Benchmark graph 150 can include a graphical depiction of a trendline of performance of one or metrics for a set duration of time. For instance, the set duration of time can be the past week, the past month, or some other set duration. In some instances, the benchmark graph generation pipeline 145 can generate and store summaries of aggregated performance metric data. For instance, every day, the past performance of each potential hierarchical group can be calculated and cached. Thus, when the hierarchical group is selected, the aggregated performance metric data can be accessed and utilized for computation without requiring real-time computation. Additionally, or alternatively, the data associated with various benchmark groups can be split into cohorts and stored across various geographies. Based on certain utilization of hierarchical groups, the system can preload raw data to make accessibility of the data easier which can in turn result in a reduction of latency and a reduction in computing resources required to make such computations.

As described above, FIG. 2 depicts an example illustration of a particular branch of a hierarchical tree of groups. For instance, the main branches of the tree can include categories 2-8 and a category for Auto & Vehicles 205. Within category 5, there can be 6 subcategories 210. Within subcategory 5-5, there can be 7 subcategories 215. Within category 5-5-2, there can be a few subcategories 220 such as visual arts, movies, concepts, and tv & videos. Within the movies subcategory, can be additional subcategories 225 such as action & adventure films, martial arts films, superhero films, western films, and animated films.

In some implementations, a device identifier can self-select a subcategory. The system can automatically assign all higher level categories to that device identifier. Additionally, or alternatively, the computing system can automatically assign a device identifier to a category and subcategory. For instance, the computing system can automatically assign a device identifier to a category based on feature data associated with the device identifier such as market, target audiences, product types, uniform resource locators, parsing a webpage associated with a URL for contextual content.

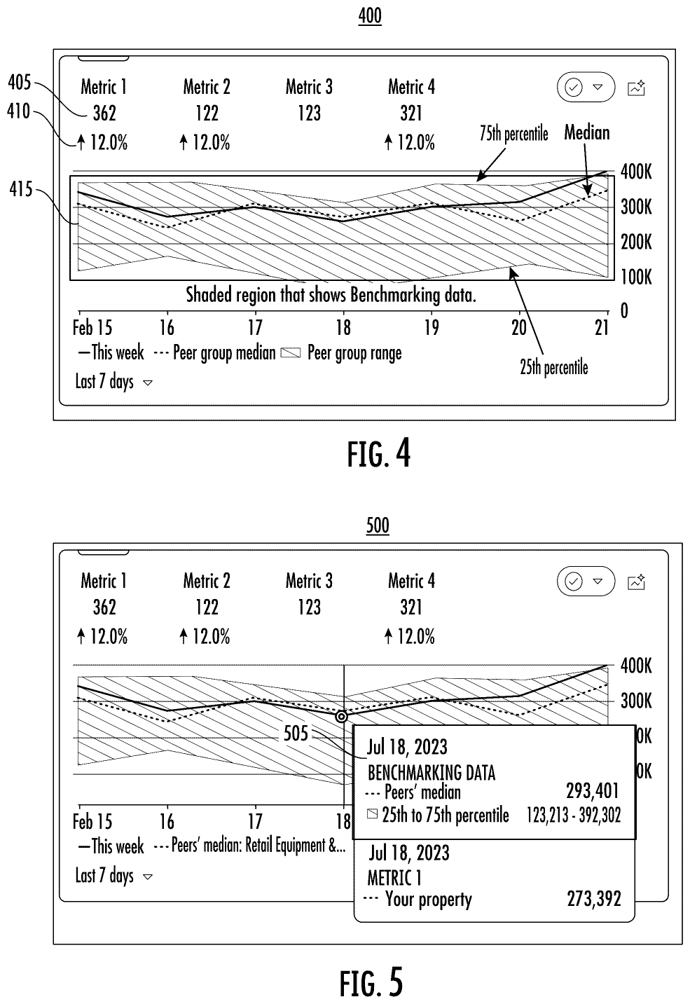

FIG. 3 depicts an example graphical user interface 300 for displaying benchmarking data for a device identifier. For instance, the solid line 305 can represent the performance of the past week for a first metric for a device identifier. In some instances, a user can provide input to toggle 310 the benchmarking data to be visible. As displayed in FIG. 3, the benchmarking data can include a shaded region 315 representing the 25^{th} to 75^{th} percentile or other quantiles determined by the system. Additionally, or alternatively, the system can provide a dotted line 320 representing the average or median associated with the benchmarking group (e.g., peer group). As depicted in FIG. 3, this view can be accessible for a number of metrics. Additionally, this or a similar view can be accessible for a number of different hierarchical groups or subgroups.

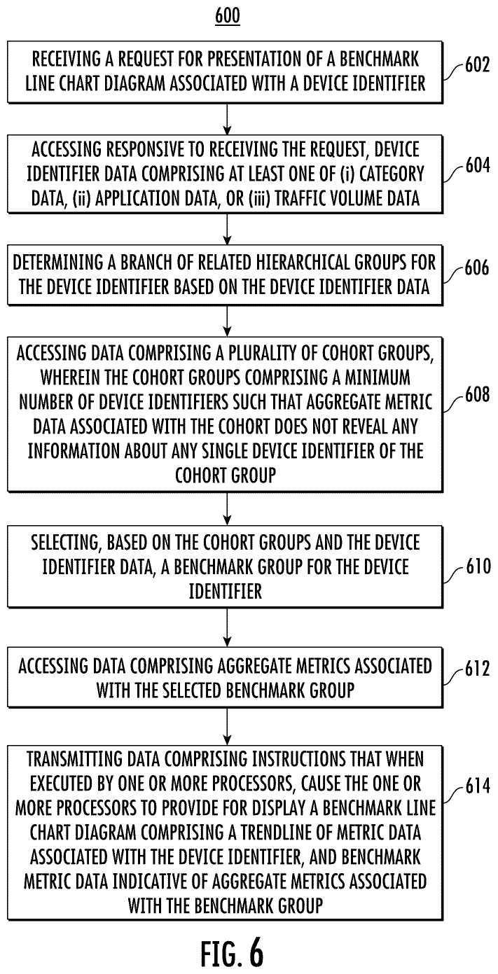

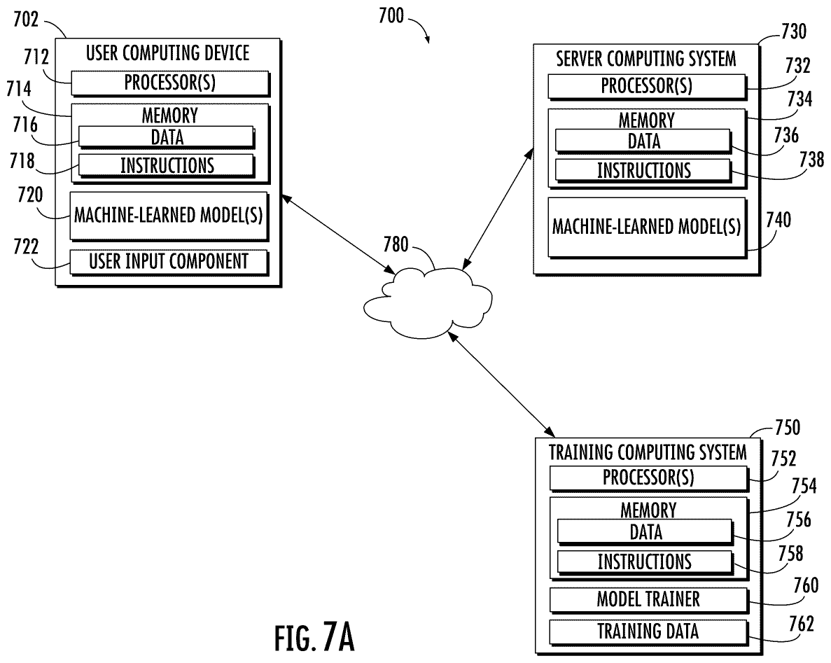

FIG. 4 and FIG. 5 depict additional example graphical user interfaces depicting benchmarking data for a device identifier as well as the associated hierarchical group.

FIG. 4 depicts a graphical user interface 400 including a number of metrics 405, increases in metrics 410 and visualizations 415 of benchmarking data.

FIG. 5 depicts a graphical user interface 500 including additional details in a pop-up interface 505 that is generated responsive to selecting a point on the benchmarking graph displayed in FIG. 4.

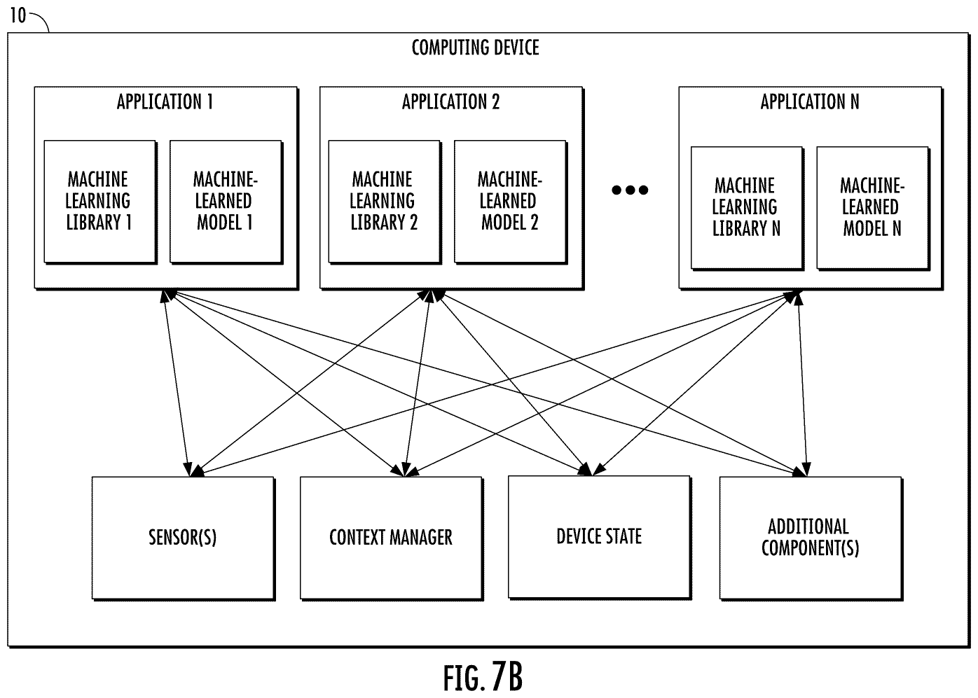

FIG. 6 depicts a flow diagram of an example method 600 in accordance with some embodiments of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, method 600 is performed by a computing device (e.g., computing device 702) or by server computing system (e.g., server computing system 730). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processors can be omitted in various embodiments. Thus, not all processes are required in every embodiment. Other process flows are possible.

At operation 602, processing logic can receive, by a computing device, a request for presentation of a benchmark line chart diagram associated with a device identifier. For instance, a user can provide input requesting a benchmark line chart diagram to be presented via a graphical user interface. A device identifier can include an identifier associated with a customer, website, or some other entity that can have associated property data, metric data, or other device identifier data.

At operation 604, processing logic can access, by the computing device, responsive to receiving the request, device identifier data comprising at least one of (i) category data, (ii) application data, or (iii) traffic volume data. Category data can include, for instance, self-reported industry category such as a category associated with a good or service associated with the device identifier. Application data can include data associated with the utilization of an application associated with the device identifier. Traffic volume data can include an amount of traffic that a website, application, or other surface associated with the device identifier can be utilized.

At operation 606, processing logic can determine, by the computing device, a branch of related hierarchical groups for the device identifier based on the device identifier data. In some instances, processing logic can determine a number of hierarchical nodes within the branch of related hierarchical groups. Processing logic can determine a group size for members of a group based on the hierarchical node and any subsequent hierarchical nodes in the branch. Processing logic can compare the group size to a threshold group size. Processing logic can, based on comparing the group size to the threshold group size, select the hierarchical node for generating the benchmark group.

At operation 608, processing logic can access, by the computing device, data comprising a plurality of cohort groups. The cohort groups can include a minimum number of device identifiers such that aggregate metric data associated with the cohort does not reveal any information about any single device identifier of the cohort group. The cohort groups can include a minimum number of data associated with device identifiers such that aggregate metric data associated with the cohort does not reveal any information about any single device identifier of the cohort group. Data associated with device identifiers can include property data. In some instances, property data can include a number of websites visits. In some implementations, the group size for each respective group of the branch of related hierarchical groups is cached. Caching the group size data can provide for decrease latency and improved processing time. In some implementations, data associated with the branch of related hierarchical groups is distributively stored and cached for a predetermined duration of time. For instance, data can be cached or otherwise stored for a predetermined duration of time such as a month, a set number of days, or some amount determined by a process or preference setting. In some instances, data can be cached based on storage utilization and availability. The distribution of data can be performed to prevent multiple calls from being made to different storage databases. In some instances, a model can predict when requests for such data will be made. In response, data can be pre-loaded or moved to certain data storage locations such that the data can be accessed directly to reduce latency.

At operation 610, processing logic can select, based on the cohort groups and the device identifier data, a benchmark group for the device identifier. For instance, the benchmark group can include a number of other device identifiers and associated accounts which share similarities to the device identifier requesting data. For instance, the benchmark group can include organizations of similar size, which target similar categories, or that are in the same industry vertical.

At operation 612, processing logic can access, by the computing device, data comprising aggregate metrics associated with the selected benchmark group. For instance, the system can determine or otherwise access aggregate metrics which can provide for an indication of various quantiles of performance. In some instances, the aggregate metrics can include time series data including a 25^{th}, 50^{th}, and 75^{th} percentile. For instance, these metrics can be determined for each day in the previous 7 days. In some instances, these values can be computed offline for various benchmark groups. Alternatively, aggregate data can be stored in a storage location accessible by a computing system associated with the device identifier such that the metrics can be generated in near-real time responsive to the request for the presentation of the benchmark line chart data.

In some implementations, the aggregate metrics include one or more normalized metrics. For instance, normalized metrics can include at least one of: a new user rate, add to carts per user rate, checkouts per user, total advertisement revenue per user, transactions per user, event count per user, event count per user session, screen page views per user, screen page views per session, user engagement duration per user, sessions per user, session conversion rate, user conversion rate, bounce rate, average session duration, engaged sessions per user, engagement rate, user engagement duration per session, daily active user compared to monthly active users, weekly active users compared to monthly active users, average revenue per user, new user per total sessions, transactions per buyer, first time buyer conversion rate, first time buyers per new users, number of distinct active users with a purchase in the past month compared to number of distinct active users on a particular data, or number of distinct active users with a purchase in the past week compared to number of distinct active users in a particular week.

In some implementations, the aggregate metrics can include one or more unnormalized metrics. For instance, the unnormalized metrics can include at least one of number of active users or number of new users.

At operation 614, processing logic can transmit, by the computing device, data comprising instructions that when executed by one or more processors, cause the one or more processors to provide for display a benchmark line chart diagram comprising a trendline of metric data associated with the device identifier, and benchmark metric data indicative of aggregate metrics associated with the benchmark group.

In some instances, processing logic can generate a data structure comprising one or more updated settings associated with a content campaign management system based on the aggregate metrics and the device identifier data metric data. For instance, the settings can be related to Advertisement bidding or other Advertisement settings.

In some instances, processing logic can update, based on the data structure, the one or more settings within the content management system.

In some instances, processing logic can reallocate, based on updating the one or more settings, one or more computing resources of the computing device.

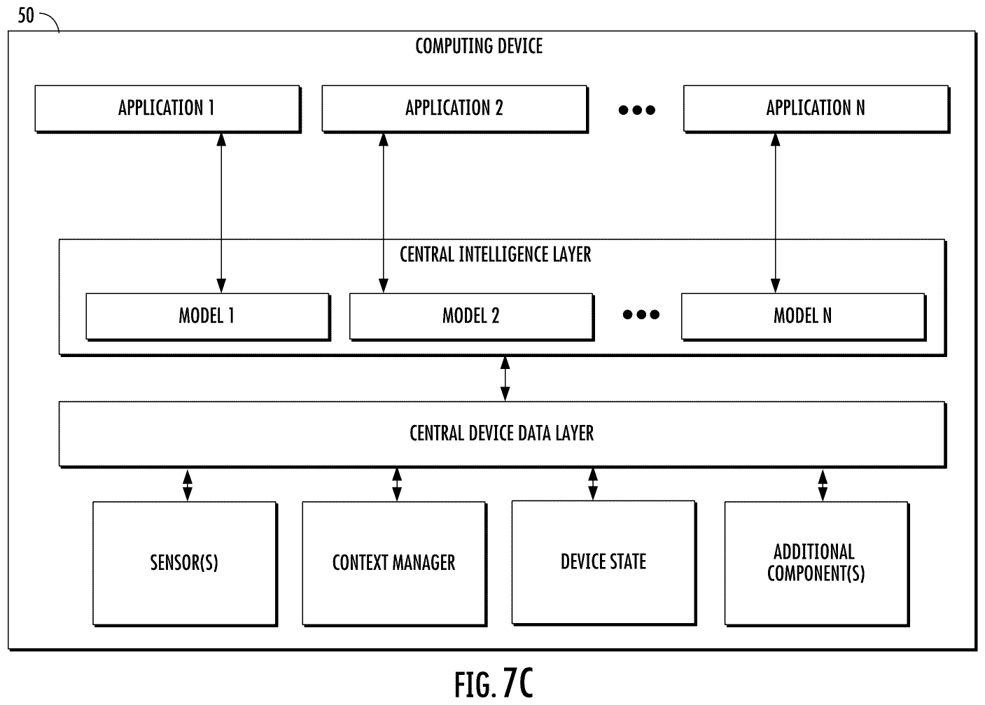

FIG. 7A depicts a block diagram of an example computing system 700 that performs benchmark group determination and benchmark data calculation and facilitation of rendering via a client device. The system 700 includes a user computing device 702, a server computing system 730, and a training computing system 750 that are communicatively coupled over a network 780.

The user computing device 702 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 702 includes one or more processors 712 and a memory 714. The one or more processors 712 can be any suitable processing device (e.g., a processor core, a microprocessor, an A SIC, an FPGA, a controller, a microcontroller, etc.) and can be one processor or a plurality of processors that are operatively connected. The memory 714 can include one or more non-transitory computer-readable storage media, such as RAM, ROM, EEPROM, EPROM, flash memory devices, magnetic disks, etc., and combinations thereof. The memory 714 can store data 716 and instructions 718 which are executed by the processor 712 to cause the user computing device 702 to perform operations.

In some implementations, the user computing device 702 can store or include one or more machine-learned models 720, such as machine-learned generation models or machine-learned evaluation models. For example, the machine-learned models 720 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 720 are discussed with reference to FIGS. 1-5.

In some implementations, the one or more machine-learned models 720 can be received from the server computing system 730 over network 780, stored in the user computing device memory 714, and then used or otherwise implemented by the one or more processors 712. In some implementations, the user computing device 702 can implement multiple parallel instances of a single machine-learned model 720 (e.g., to perform parallel insight summary generation or evaluation across multiple instances of machine-learned generation model or machine-learned evaluation model).

Additionally, or alternatively, one or more machine-learned models 740 (e.g., machine-learned generation models, machine-learned evaluation models, etc.) can be included in or otherwise stored and implemented by the server computing system 730 that communicates with the user computing device 702 according to a client-server relationship. For example, the machine-learned models 740 can be implemented by the server computing system 730 as a portion of a web service (e.g., an advertising analytics service, etc.). Thus, one or more models 720 can be stored and implemented at the user computing device 702 and/or one or more models 740 can be stored and implemented at the server computing system 730.

The user computing device 702 can also include one or more user input components 722 that receives user input. For example, the user input component 722 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 730 includes one or more processors 732 and a memory 734. The one or more processors 732 can be any suitable processing device (e.g., a processor core, a microprocessor, an A SIC, an FPGA, a controller, a microcontroller, etc.) and can be one processor or a plurality of processors that are operatively connected. The memory 734 can include one or more non-transitory computer-readable storage media, such as RAM, ROM, EEPROM, EPROM, flash memory devices, magnetic disks, etc., and combinations thereof. The memory 734 can store data 736 and instructions 738 which are executed by the processor 732 to cause the server computing system 730 to perform operations.

In some implementations, the server computing system 730 includes or is otherwise implemented by one or more server computing devices. In instances in which the server computing system 730 includes plural server computing devices, such server computing devices can operate according to sequential computing architectures, parallel computing architectures, or some combination thereof.

As described above, the server computing system 730 can store or otherwise include one or more machine-learned models 740 (e.g., machine-learned generation models, machine-learned evaluation models, etc.). For example, the models 740 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 740 are discussed with reference to FIGS. 1-5.

The user computing device 702 and/or the server computing system 730 can train the models 720 and/or 740 via interaction with the training computing system 750 that is communicatively coupled over the network 780. The training computing system 750 can be separate from the server computing system 730 or can be a portion of the server computing system 730.

The training computing system 750 includes one or more processors 752 and a memory 754. The one or more processors 752 can be any suitable processing device (e.g., a processor core, a microprocessor, an A SIC, an FPGA, a controller, a microcontroller, etc.) and can be one processor or a plurality of processors that are operatively connected. The memory 754 can include one or more non-transitory computer-readable storage media, such as RAM, ROM, EEPROM, EPROM, flash memory devices, magnetic disks, etc., and combinations thereof. The memory 754 can store data 756 and instructions 758 which are executed by the processor 752 to cause the training computing system 750 to perform operations. In some implementations, the training computing system 750 includes or is otherwise implemented by one or more server computing devices.

The training computing system 750 can include a model trainer 760 that trains the machine-learned models 720 and/or 740 stored at the user computing device 702 and/or the server computing system 730 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. The training can implement supervised learning, unsupervised learning, reinforcement learning, etc.

In some implementations, performing backwards propagation of errors can include performing truncated backpropagation through time. The model trainer 760 can perform a number of generalization techniques (e.g., weight decays, dropouts, etc.) to improve the generalization capability of the models being trained.

In some implementations, the model(s) 720 can be pre-trained before domain-specific alignment. For instance, a model 720 can be pretrained over a general corpus of training data and fine-tuned on a more targeted corpus of training data. A model 720 can be aligned using prompts that are designed to elicit domain-specific outputs. Prompts can be designed to include learned prompt values (e.g., soft prompts). The trained model(s) 720 may be validated prior to their use using input data other than the training data and may be further updated or refined during their use based on additional feedback/inputs.

In particular, the model trainer 760 can train the machine-learned models 720 and/or 740 based on a set of training data 762. Training data 762 for the machine-learned generation model can include, for example, input-output pairs comprising structured insight data as inputs, and example outputs as outputs. Training data 762 for the machine-learned evaluation model can include, for example, input-output pairs comprising candidate outputs as inputs, and evaluations (e.g., numerical evaluation scores, etc.) as outputs. In some instances, training data 762 for the machine-learned evaluation model can also include structured insight data as part of the inputs of each input-output pair. In some instances, training data 762 for the machine-learned generation model or machine-learned evaluation model can include, for example, input-output pairs comprising structured insight data as inputs, and feedback inputs as outputs.

In some implementations, if the user has provided consent, the training examples can be provided by the user computing device 702. Thus, in such implementations, the model 720 provided to the user computing device 702 can be trained by the training computing system 750 on user-specific data received from the user computing device 702. In some instances, this process can be referred to as personalizing the model.

The model trainer 760 includes computer logic utilized to provide desired functionality. The model trainer 760 can be implemented in hardware, firmware, and/or software controlling a general purpose processor. For example, in some implementations, the model trainer 760 includes program files stored on a storage device, loaded into a memory and executed by one or more processors. In other implementations, the model trainer 760 includes one or more sets of computer-executable instructions that are stored in a tangible computer-readable storage medium such as RAM, hard disk, or optical or magnetic media.

The network 780 can be any type of communications network, such as a local area network (e.g., intranet), wide area network (e.g., Internet), or some combination thereof and can include any number of wired or wireless links. In general, communication over the network 780 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 7A illustrates one example computing system that can be used to implement the present disclosure. Other computing systems can be used as well. For example, in some implementations, the user computing device 702 can include the model trainer 760 and the training dataset 762. In such implementations, the models 720 can be both trained and used locally at the user computing device 702. In some of such implementations, the user computing device 702 can implement the model trainer 760 to personalize the models 720 based on user-specific data.

FIG. 7B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 7B, each application can communicate with a number of other components of the computing device, such as, for example, one or more sensors, a context manager, a device state component, and/or additional components. In some implementations, each application can communicate with each device component using an API (e.g., a public A PI). In some implementations, the A PI used by each application is specific to that application.

FIG. 7C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 7C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 7C, the central device data layer can communicate with a number of other components of the computing device, such as, for example, one or more sensors, a context manager, a device state component, and/or additional components. In some implementations, the central device data layer can communicate with each device component using an API (e.g., a private API).

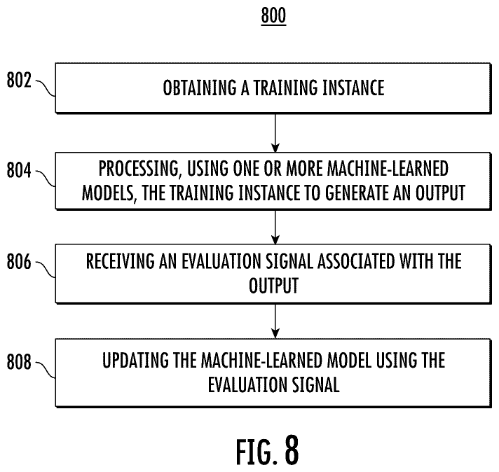

FIG. 8 depicts a flowchart of a method 800 for training one or more machine-learned models according to aspects of the present disclosure. For instance, an example machine-learned model can include a machine-learned generation model or machine-learned evaluation model).

One or more portion(s) of example method 800 can be implemented by a computing system that includes one or more computing devices such as, for example, computing systems described with reference to the other figures. Each respective portion of example method 800 can be performed by any (or any combination) of one or more computing devices. Moreover, one or more portion(s) of example method 800 can be implemented on the hardware components of the device(s) described herein, for example, to train one or more systems or models. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of example method 800 can be performed additionally, or alternatively, by other systems.

At 802, example method 800 can include obtaining a training instance. A set of training data can include a plurality of training instances divided between multiple datasets (e.g., a training dataset, a validation dataset, or testing dataset). A training instance can be labeled or unlabeled. Although referred to in example method 800 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 804, example method 800 can include processing, using one or more machine-learned models, the training instance to generate an output. The output can be directly obtained from the one or more machine-learned models or can be a downstream result of a chain of processing operations that includes an output of the one or more machine-learned models.

At 806, example method 800 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 808, example method 800 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 800 can include implementing a number of generalization techniques (e.g., weight decays, dropouts, etc.) to improve the generalization capability of the models being trained.

In some implementations, example method 800 can be implemented for training a machine-learned model from an initialized state to a fully trained state (e.g., when the model exhibits a desired performance profile, such as based on accuracy, precision, recall, etc.).

In some implementations, example method 800 can be implemented for particular stages of a training procedure. For instance, in some implementations, example method 800 can be implemented for pre-training a machine-learned model. Pre-training can include, for instance, large-scale training over potentially noisy data to achieve a broad base of performance levels across a variety of tasks/data types. In some implementations, example method 800 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

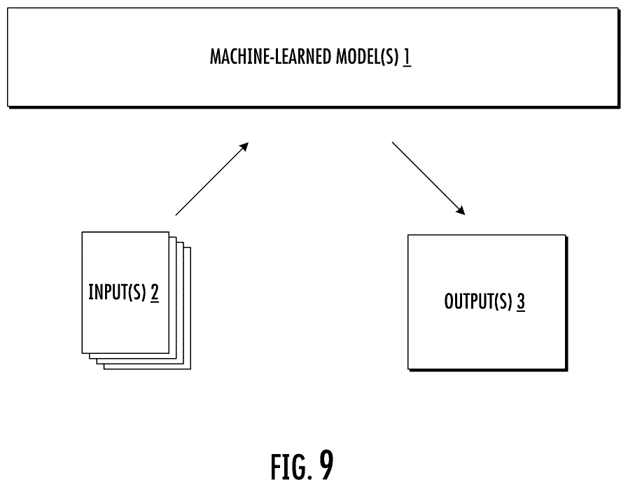

FIG. 9 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

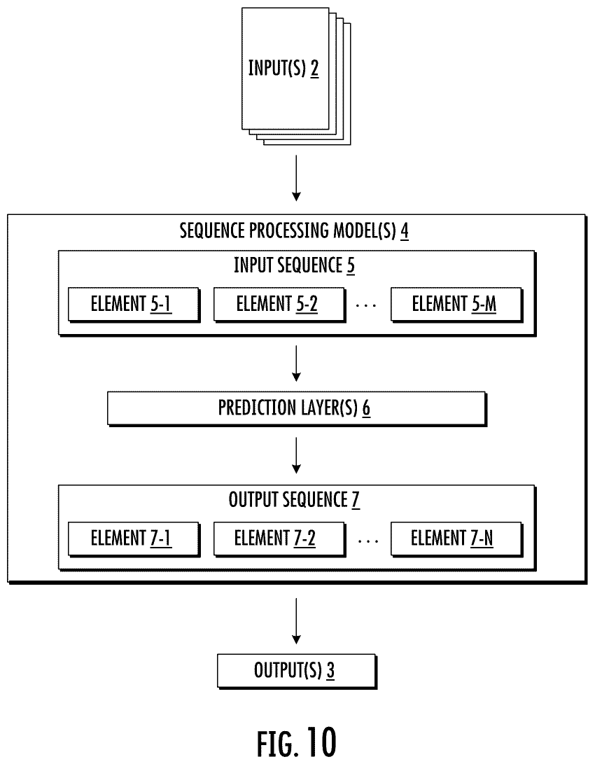

FIG. 10 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicL M: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (B PE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D 18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 10 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

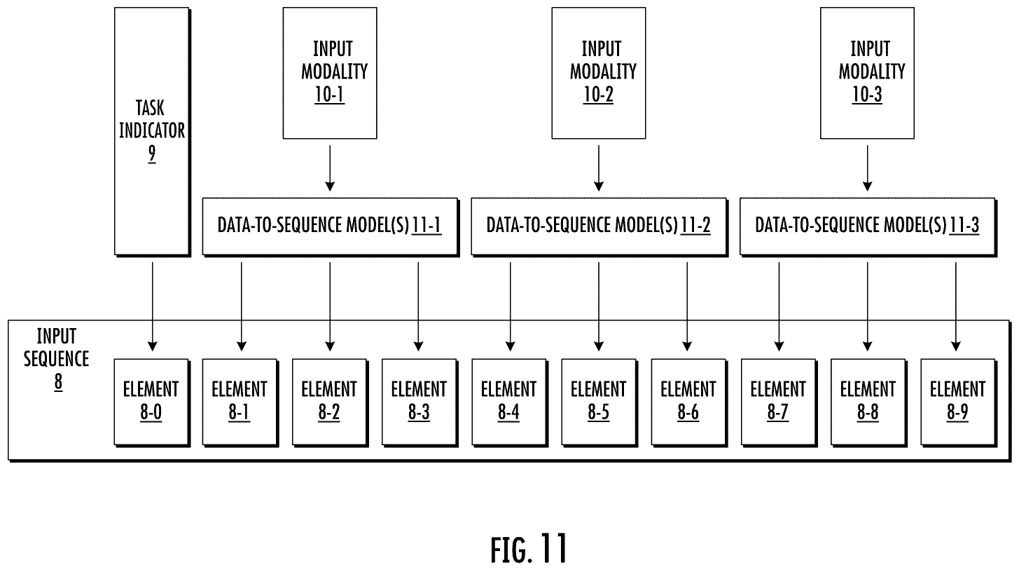

FIG. 11 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

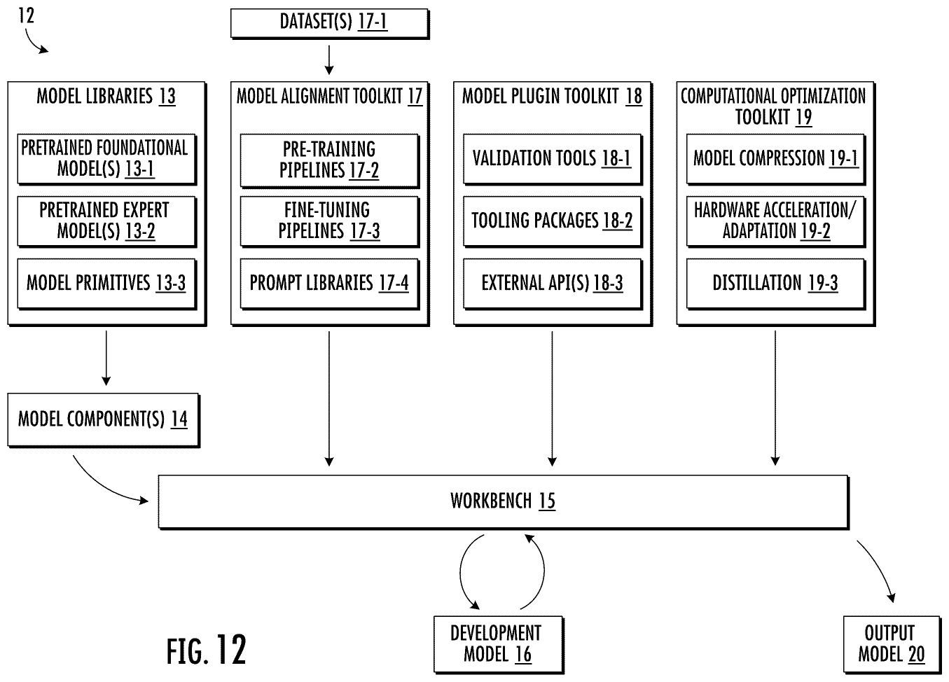

FIG. 12 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 800 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models−e.g., understanding an intent in an unstructured request for a task−while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

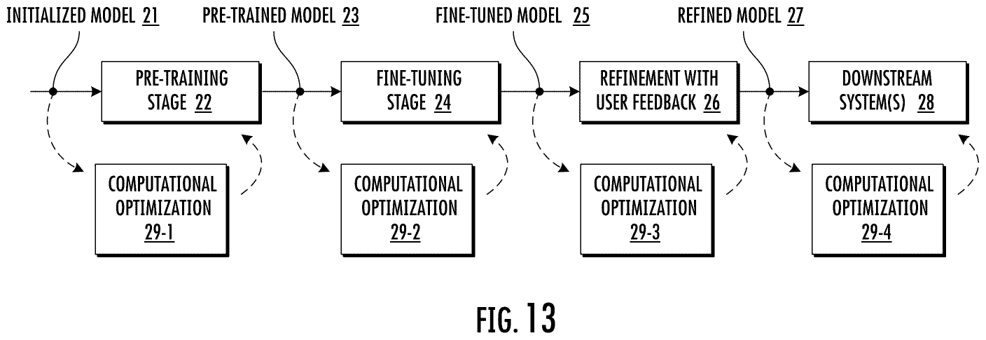

FIG. 13 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 13 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 25 can then be a new version of development model 16, which can persist as development model 16 or as a new development model. Fine-tuned model 25 can be the initial state if development model 16 was already fine-tuned. Fine-tuned model 25 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

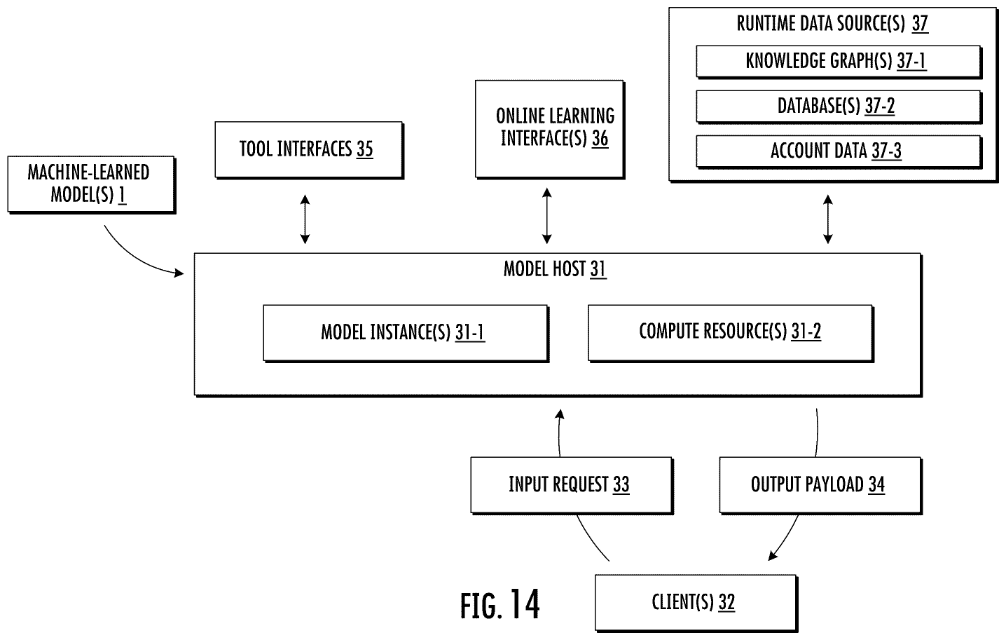

FIG. 14 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote A Pls. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method, comprising:
receiving, by a computing device, a request for presentation of a benchmark line chart diagram associated with a device identifier;
accessing, by the computing device, responsive to receiving the request, device identifier data comprising at least one of (i) category data, (ii) application data, or (iii) traffic volume data;
determining, by the computing device, a branch of related hierarchical groups for the device identifier based on the device identifier data;
accessing, by the computing device, data comprising a plurality of cohort groups, wherein the cohort groups comprising a minimum number of device identifiers such that aggregate metric data associated with the cohort does not reveal any information about any single device identifier of the cohort group;
selecting, based on the cohort groups and the device identifier data, a benchmark group for the device identifier;
accessing, by the computing device, data comprising aggregate metrics associated with the selected benchmark group; and
transmitting, by the computing device, data comprising instructions that when executed by one or more processors, cause the one or more processors to provide for display a benchmark line chart diagram comprising a trendline of metric data associated with the device identifier, and benchmark metric data indicative of aggregate metrics associated with the benchmark group.

2. The computer-implemented method of claim 1, comprising:
generating, by the computing device, a data structure comprising one or more updated settings associated with a content campaign management system based on the aggregate metrics and the device identifier data metric data;
updating, based on the data structure, the one or more settings within the content management system; and
reallocating, based on updating the one or more settings, one or more computing resources of the computing device.

3. The computer-implemented method of claim 1, wherein determining, by the computing device, the branch of related hierarchical groups for the device identifier based on the device identifier data comprising:
determining a plurality of hierarchical nodes within the branch of related hierarchical groups;
determining a group size for members of a group based on the hierarchical node and any subsequent hierarchical nodes in the branch;
comparing the group size to a threshold group size; and
based on comparing the group size to the threshold group size, selecting the hierarchical node for generating the benchmark group.

4. The computer-implemented method of claim 1, wherein a group size for each respective group of the branch of related hierarchical groups is cached.

5. The computer-implemented method of claim 1, wherein data associated with the branch of related hierarchical groups is distributively stored and cached for a predetermined duration of time.

6. The computer-implemented method of claim 1, wherein the aggregate metrics comprise one or more normalized metrics.

7. The computer-implemented method of claim 6, wherein the normalized metrics comprise at least one of: a new user rate, add to carts per user rate, checkouts per user, total advertisement revenue per user, transactions per user, event count per user, event count per user session, screen page views per user, screen page views per session, user engagement duration per user, sessions per user, session conversion rate, user conversion rate, bounce rate, average session duration, engaged sessions per user, engagement rate, user engagement duration per session, daily active user compared to monthly active users, weekly active users compared to monthly active users, average revenue per user, new user per total sessions, transactions per buyer, first time buyer conversion rate, first time buyers per new users, number of distinct active users with a purchase in the past month compared to number of distinct active users on a particular data, or number of distinct active users with a purchase in the past week compared to number of distinct active users in a particular week.

8. The computer-implemented method of claim 1, wherein the aggregate metrics comprise one or more unnormalized metrics.

9. The computer-implemented method of claim 8, wherein the one or more unnormalized metrics comprises at least one of number of active users or number of new users.

10. A computing system comprising:
one or more processors; and
one or more computer-readable media storing instructions that are executable to cause the
one or more processors to perform operations, the operations comprising:
receiving, by a computing device, a request for presentation of a benchmark line chart diagram associated with a device identifier;
accessing, by the computing device, responsive to receiving the request, device identifier data comprising at least one of (i) category data, (ii) application data, or (iii) traffic volume data;
determining, by the computing device, a branch of related hierarchical groups for the device identifier based on the device identifier data;
accessing, by the computing device, data comprising a plurality of cohort groups, wherein the cohort groups comprising a minimum number of device identifiers such that aggregate metric data associated with the cohort does not reveal any information about any single device identifier of the cohort group;
selecting, based on the cohort groups and the device identifier data, a benchmark group for the device identifier;
accessing, by the computing device, data comprising aggregate metrics associated with the selected benchmark group; and
transmitting, by the computing device, data comprising instructions that when executed by one or more processors, cause the one or more processors to provide for display a benchmark line chart diagram comprising a trendline of metric data associated with the device identifier, and benchmark metric data indicative of aggregate metrics associated with the benchmark group.

11. The computing system of claim 10, comprising:
generating, by the computing device, a data structure comprising one or more updated settings associated with a content campaign management system based on the aggregate metrics and the device identifier data metric data;
updating, based on the data structure, the one or more settings within the content management system; and
reallocating, based on updating the one or more settings, one or more computing resources of the computing device.

12. The computing system of claim 10, wherein determining, by the computing device, the branch of related hierarchical groups for the device identifier based on the device identifier data comprising:
determining a plurality of hierarchical nodes within the branch of related hierarchical groups;
determining a group size for members of a group based on the hierarchical node and any subsequent hierarchical nodes in the branch;
comparing the group size to a threshold group size; and
based on comparing the group size to the threshold group size, selecting the hierarchical node for generating the benchmark group.

13. The computing system of claim 10, wherein a group size for each respective group of the branch of related hierarchical groups is cached.

14. The computing system of claim 10, wherein data associated with the branch of related hierarchical groups is distributively stored and cached for a predetermined duration of time.

15. The computing system of claim 10, wherein the aggregate metrics comprise one or more normalized metrics.

16. The computing system of claim 15, wherein the normalized metrics comprise at least one of: a new user rate, add to carts per user rate, checkouts per user, total advertisement revenue per user, transactions per user, event count per user, event count per user session, screen page views per user, screen page views per session, user engagement duration per user, sessions per user, session conversion rate, user conversion rate, bounce rate, average session duration, engaged sessions per user, engagement rate, user engagement duration per session, daily active user compared to monthly active users, weekly active users compared to monthly active users, average revenue per user, new user per total sessions, transactions per buyer, first time buyer conversion rate, first time buyers per new users, number of distinct active users with a purchase in the past month compared to number of distinct active users on a particular data, or number of distinct active users with a purchase in the past week compared to number of distinct active users in a particular week.

17. The computing system of claim 10, wherein the aggregate metrics comprise one or more unnormalized metrics.

18. The computing system of claim 17, wherein the one or more unnormalized metrics comprises at least one of number of active users or number of new users.

19. One or more transitory or non-transitory computer-readable media storing instructions that are executable by one or more processors to perform operations comprising:
receiving, by a computing device, a request for presentation of a benchmark line chart diagram associated with a device identifier;
accessing, by the computing device, responsive to receiving the request, device identifier data comprising at least one of (i) category data, (ii) application data, or (iii) traffic volume data;
determining, by the computing device, a branch of related hierarchical groups for the device identifier based on the device identifier data;
accessing, by the computing device, data comprising a plurality of cohort groups, wherein the cohort groups comprising a minimum number of device identifiers such that aggregate metric data associated with the cohort does not reveal any information about any single device identifier of the cohort group;
selecting, based on the cohort groups and the device identifier data, a benchmark group for the device identifier;
accessing, by the computing device, data comprising aggregate metrics associated with the selected benchmark group; and
transmitting, by the computing device, data comprising instructions that when executed by one or more processors, cause the one or more processors to provide for display a benchmark line chart diagram comprising a trendline of metric data associated with the device identifier, and benchmark metric data indicative of aggregate metrics associated with the benchmark group.

20. The one or more transitory or non-transitory computer-readable media of claim 19, the operations comprising:
generating, by the computing device, a data structure comprising one or more updated settings associated with a content campaign management system based on the aggregate metrics and the device identifier data metric data;
updating, based on the data structure, the one or more settings within the content management system; and
reallocating, based on updating the one or more settings, one or more computing resources of the computing device.
